(19) United States
(12) Patent Application Publication
(10) Pub. No.: US 2015/0152919 A1
(43) Pub. Date: Jun. 4, 2015

(54) BEARING ASSEMBLY WITH CAGE AXIAL RETENTION

(71) Applicant: Schaeffler Technologies AG & Co. KG, Herzogenaurach (DE)

(72) Inventor: Alaa Makke, West Bloomfield, MI (US)

(73) Assignee: Schaeffler Technologies AG & Co. KG, Herzogenaurach (DE)

(21) Appl. No.: 14/616,918

(22) Filed: Feb. 9, 2015

(51) Int. Cl. F16C 33/46; F16C 19/26; F16C 33/58

(52) U.S. Cl. CPC F16C 33/4605; F16C 33/585; F16C 19/26

(57) ABSTRACT

A bearing cage in a bearing assembly, including: an outer ring with a radially outer and inner circumferential surface, the inner surface including a raceway and at least one groove in a cage guide surface; a cage axially and radially aligned and within the outer ring, including: a cylindrical wall having first and second axial ends and radially inner and outer circumferential surfaces; the outer circumferential surface having a protrusion in a guide surface that is radially and axially aligned with the mating groove in the outer ring. The groove and protrusion aligned and mating such that relative axial movement between the cage and outer ring are limited.

### TECHNICAL FIELD

The present disclosure relates to a bearing and bearing cage with axial retention features, in particular, a bearing ring and bearing cage with mating features to limit axial movement of the cage relative to the bearing ring.

### BACKGROUND

FIG. 8 is a side cross sectional view of a prior art bearing assembly 200, in this case a needle bearing, with cage 20, outer ring 210 and axis LA. Outer ring 210 has a radially inner circumferential surface 210A that includes a race that rolling elements 203 run on, a land or guide surface 212 that cage or rolling element guide 204 at least is partially guided by, and seal retention groove 215 in which seal 216 is inserted and retained. Cage 201 includes cylindrical wall 204 pierced by slots 202 in which are inserted and retained rolling elements 203, in this case needle rollers, and cylindrical wall guide surfaces 205 that at least partially run on and are guided by outer ring guide surfaces 212. Cylindrical wall guide surfaces 205 and outer ring guide surface 212 are smooth cylindrical surfaces, without mating contours. As a result of the smooth running surfaces, during operation and rotation of the bearing, there can be relative axial movement between cage 201 and outer ring 210, causing contact with adjacent seal 216 and seal lips 217. This contact may, in turn, cause dragging of the cage as well as wear of the seal material into the bearing. This contact may be limited by small tolerances to avoid large geometric stack ups of the various parts. Limiting this axial movement is desirable.

### SUMMARY

According to aspects illustrated herein, there is provided a bearing assembly including: a cylindrical outer ring including: first and second axial ends; a radially inner circumferential surface and a radially outer circumferential surface; a bearing race on the radially inner circumferential surface; and, at least one circumferential groove extending around the radially inner circumferential surface of the outer ring, between the bearing race and at least one of the first and second axial ends; a cylindrical rolling element guide radially aligned within the outer ring including; a cylindrical wall having a radially inner circumferential surface and a radially outer circumferential surface and first and second axial ends; a plurality of slots in the cylindrical wall arranged to retain rolling elements; and at least one circumferential protrusion extending at least 180 degrees around the radially outer cylindrical surface of the cylindrical wall between the slots and the first or second axial ends of the rolling element guide; and the circumferential protrusion radially and axially aligned with the circumferential groove and at least partially mating with each other, such that relative axial movement is limited between the outer ring and the rolling element guide.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a perspective view of a cylindrical coordinate system demonstrating spatial terminology used in the present application;

FIG. 2 is a cross sectional view of a bearing assembly with a cage axial retention feature according to one example embodiment;

FIG. 3 is an enlarged view of a portion of the bearing assembly of FIG. 2;

FIG. 4 is an enlarged view of a portion of the bearing assembly of FIG. 2, showing an alternate example embodiment;

FIG. 5 is a perspective view of the cage of FIG. 2;

FIG. 6 is an enlarged view of a bottom section of the cage of FIG. 5;

FIG. 7 is a perspective view of a half section of the outer ring of FIG. 2; and

FIG. 8 is a cross sectional view of a prior art bearing assembly.

### DETAILED DESCRIPTION

At the outset, it should be appreciated that like drawing numbers on different drawing views identify identical, or functionally similar, structural elements of the disclosure. It is to be understood that the disclosure as claimed is not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the present disclosure.

Unless defined otherwise, all technical and scientific terms used herein have the same meaning as commonly understood to one of ordinary skill in the art to which this disclosure belongs. It should be understood that any methods, devices or materials similar or equivalent to those described herein can be used in the practice or testing of the disclosure.

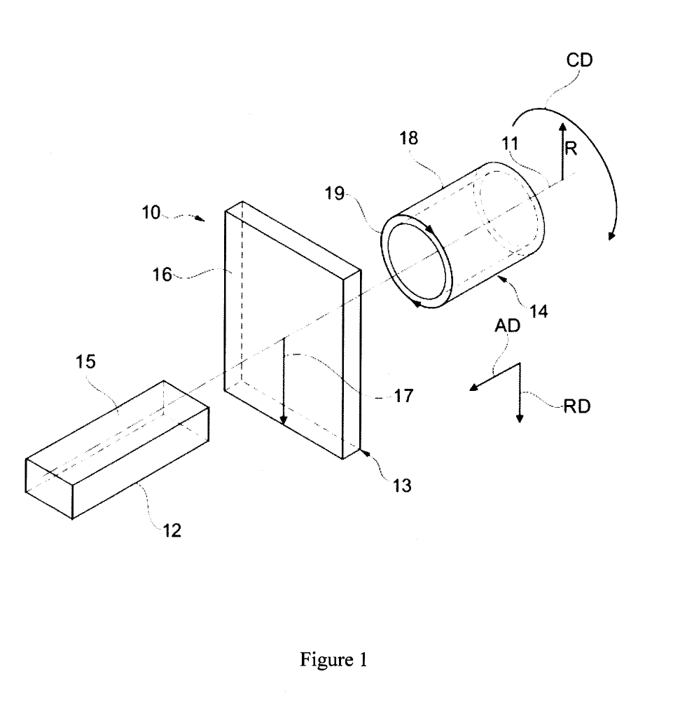

FIG. 1 is a perspective view of cylindrical coordinate system 10 demonstrating spatial terminology used in the present application. The present application is at least partially described within the context of a cylindrical coordinate system. System 10 includes longitudinal axis 11, used as the reference for the directional and spatial terms that follow. Axial direction AD is parallel to axis 11. Radial direction RD is orthogonal to axis 11. Circumferential direction CD is defined by an endpoint of radius R (orthogonal to axis 11) rotated about axis 11.

To clarify the spatial terminology, objects 12, 13, and 14 are used. An axial surface, such as surface 15 of object 12, is formed by a plane co-planar with axis 11. Axis 11 passes through planar surface 15; however any planar surface co-planar with axis 11 is an axial surface. A radial surface, such as surface 16 of object 13, is formed by a plane orthogonal to axis 11 and co-planar with a radius, for example, radius 17. Radius 17 passes through planar surface 16; however any planar surface co-planar with radius 17 is a radial surface. Surface 18 of object 14 forms a circumferential, or cylindrical, surface. For example, circumference 19 passes through surface 18. As a further example, axial movement is parallel to axis 11, radial movement is orthogonal to axis 11, and circumferential movement is parallel to circumference 19. Rotational movement is with respect to axis 11. The adverbs “axially,” “radially,” and “circumferentially” refer to orientations parallel to axis 11, radius 17, and circumference 19, respectively. For example, an axially disposed surface or edge extends in direction AD, a radially disposed surface or edge extends in direction R, and a circumferentially disposed surface or edge extends in direction CD.

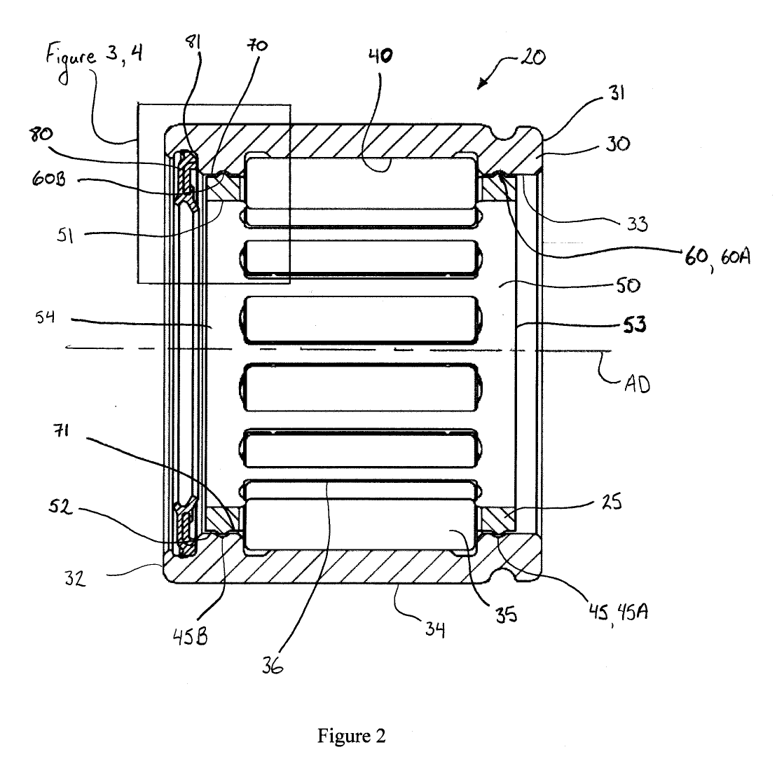

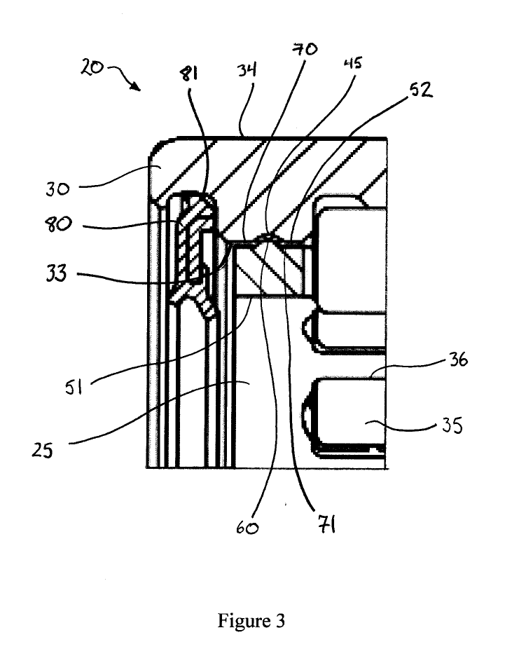

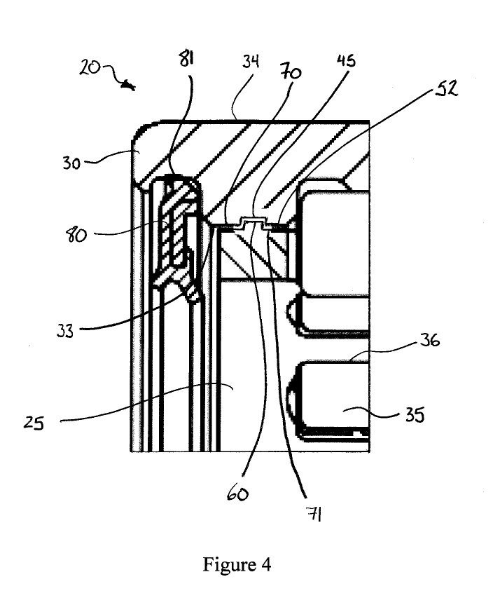

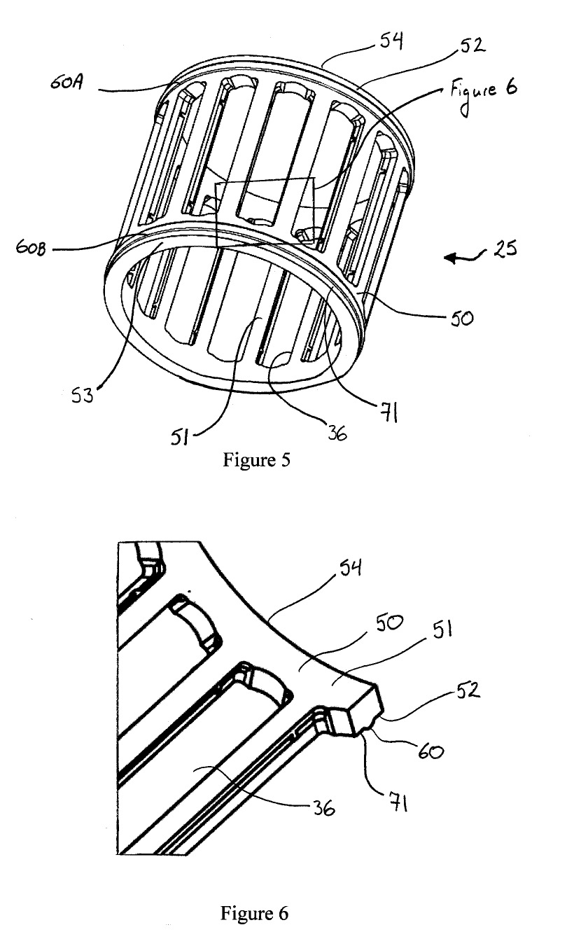

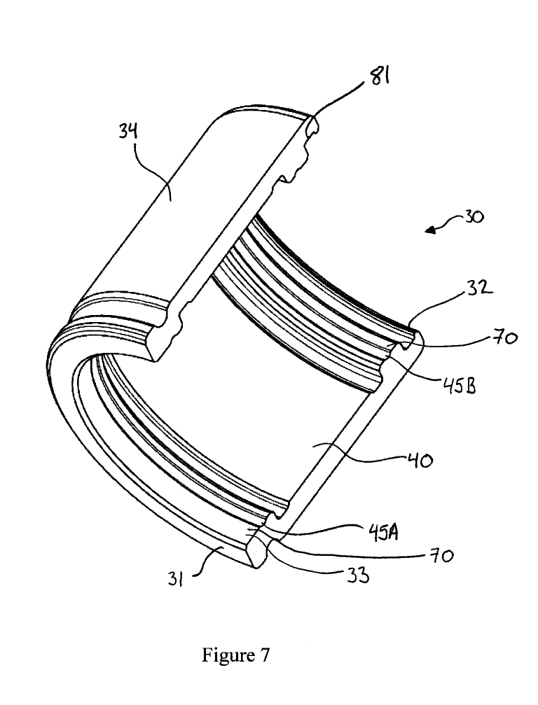

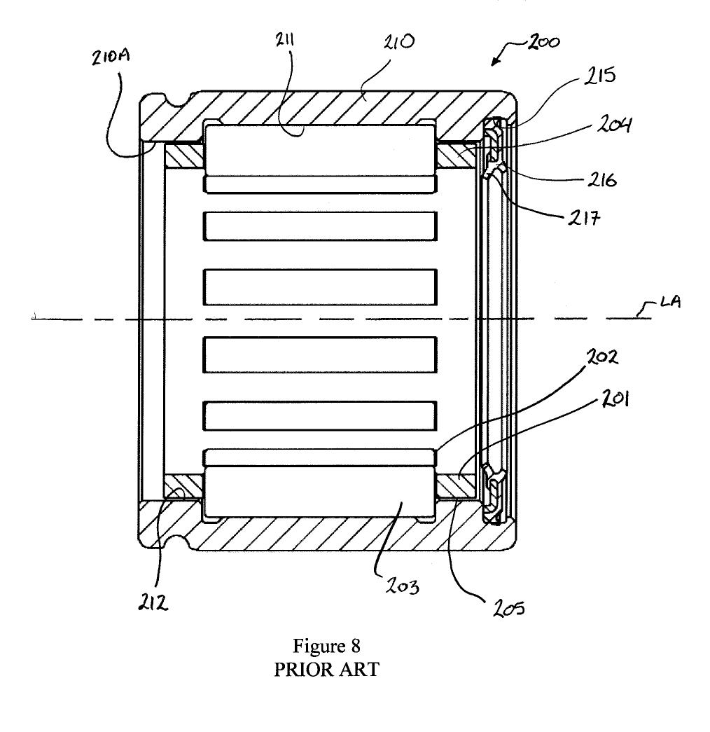

FIG. 2 is a cross sectional view of bearing assembly 20 according to one example embodiment. FIG. 3 is an enlarged view of a portion of bearing assembly 20 of FIG. 2. FIG. 4 is an enlarged view of a portion of bearing assembly 20 of FIG. 2, showing an alternate example embodiment. FIG. 5 is a perspective view of cage 25 of FIG. 2. FIG. 6 is an enlarged view of a bottom section of cage 25 of FIG. 5. FIG. 7 is a perspective view of a half section of outer ring 30 of FIG. 2. The following should be viewed in light of FIGS. 2 through 7. Bearing assembly 20 includes; axis AD; cylindrical outer ring 30 having first axial end 31, second axial end 32, radially inner circumferential surface 33 and a radially outer circumferential surface 34; cylindrical rolling element guide or cage 25 radially aligned within outer ring 30; and rolling elements 35 retained in slots 36 in cage 25. Outer ring 30 includes bearing race 40 and cage guide surface 70 on radially inner circumferential surface 33 and at least one circumferential groove 45 extending circumferentially around cage guide surface 70 of radially inner circumferential surface 33 of outer ring 30, between bearing race 40 and at least one of the first axial end 31 and second axial end 32. Cage or rolling element guide 25 includes cylindrical wall 50 having radially inner circumferential surface 51 and radially outer circumferential surface 52 with guide surface 71, first axial end 53 and second axial end 54, plurality of slots 36 perforating cylindrical wall 50, the slots formed to retain rolling elements 35, and at least one circumferential protrusion 60 elevated from guide surface 71 and extending at least 180 degrees around guide surface 71 of radially outer cylindrical surface 52 of cylindrical wall 50 between slots 36 and first axial end 53 or second axial end 54. Circumferential protrusion 60 radially and axially aligns with and at least partially mates with circumferential groove 45 such that relative axial movement is limited between outer ring 30 and rolling element guide 25. In the embodiment shown, there are two grooves 45, 45A and 45B at opposite axial ends of outer ring 30 and two protrusions 60, 60A and 60B at opposite axial ends of cage 25, with groove 45A and protrusion 60A aligning and mating, and groove 45B and protrusion 60B aligning and mating. Although two mating grooves 45 and protrusions 60 are shown, it will be understood by one skilled in the art that only one mating groove and protrusion can be used.

Protrusion 60 and groove 45 have mating cross sectional shapes, with groove 45 having a concave form and protrusion 60 having a convex form of whatever suitable cross-sectional shape is used. For example, in FIG. 3, protrusion 60 has a semi-circular or rounded convex cross-sectional form, and groove 45 has a mating semi-circular or rounded concave cross-sectional form. Alternatively, FIG. 4 shows an embodiment wherein protrusion 60 has a rectangular or otherwise polygonal convex form and groove 45 has a mating rectangular or otherwise polygonal form.

Bearing assembly 20 also includes seal 80 retained in seal recess 81 in outer ring 30. Seal 80 is shown only at axial end 34 of outer ring 30, however, one of skill in the art will understand that seals may be at both ends, either end, or there may be no seals without varying the scope of the present application. It should be understood that cage 25 can include multiple protrusions 60 on each end or a combination of multiple protrusions at one end and one or no protrusions at the other end, with an equal number of mating grooves 45 on outer ring 30 without varying the scope of the present application. By varying the number of protrusions 60 from one axial end to the other, the protrusions may also be used as orientation features during assembly, if needed. It should also be understood that cage 25 is not limited to the configuration of slots 36 or rolling elements 35 in FIGS. 2 through 7. These are example slots and rolling elements, and other rolling elements, for example balls, or slot configurations are contemplated.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

1. A bearing assembly, comprising:
a cylindrical outer ring including;
first and second axial ends;
a radially inner circumferential surface and a radially outer circumferential surface;
a bearing race on the radially inner circumferential surface; and,
at least one circumferential groove extending around the radially inner circumferential surface of the outer ring, between the bearing race and at least one of the first and second axial ends;
a cylindrical rolling element guide radially aligned within the outer ring including;
a cylindrical wall having a radially inner circumferential surface and a radially outer circumferential surface and first and second axial ends;
a plurality of slots in the cylindrical wall arranged to retain rolling elements; and
at least one circumferential protrusion extending at least 180 degrees around the radially outer cylindrical surface of the cylindrical wall between the slots and the first or second axial ends of the rolling element guide; and
the circumferential protrusion radially and axially aligned with the circumferential groove and at least partially mating with each other, such that relative axial movement is limited between the outer ring and the rolling element guide.

2. The bearing assembly of claim 1, wherein the at least one groove is two grooves, including;
a first groove between the race and the first axial end; and
a second groove between the race and the second axial end;
the at least one protrusion is two protrusions including;
a first protrusion between the slots and the first axial end; and
a second protrusion between the slots and the second axial end;
the first groove radially and axially aligned and mating with the first protrusion; and
the second groove radially and axially aligned and mating with the second protrusion.

3. The bearing assembly of claim 1, wherein the at least one groove is of a convex semi-circular cross section and the at least one protrusion is a mating concave semi-circular cross section.

4. The bearing assembly of claim 1, wherein the cylindrical outer ring further includes a seal retention feature extending around the radially inner circumferential surface of the outer ring, between the at least one circumferential groove and at least one of the first and second axial ends; and
a disc-shaped seal retained within the seal retention feature.

5. A cage for a bearing, comprising:
a cylindrical wall having a radially inner circumferential surface and a radially outer circumferential surface and first and second axial ends;
a plurality of slots in the cylindrical wall arranged to retain rolling elements;
at least one circumferential protrusion extending at least 180 degrees around the radially outer cylindrical surface of the cylindrical wall between the slots and the first or second axial ends of the cage; and
the circumferential protrusion arranged to mate with a bearing outer ring groove such that relative axial movement is limited between the outer ring and the cage.

6. The cage of claim 5, wherein the at least one protrusion is two protrusions including;
a first protrusion between the slots and the first axial end; and
a second protrusion between the slots and the second axial end.

7. The cage of claim 5, wherein the at least one protrusion has a concave semi-circular cross section.

8. The cage of claim 5, wherein the at least one protrusion has a polygon cross section.
